(19) United States
(12) Patent Application Publication
(10) Pub. No.: US 2026/0094424 A1
(43) Pub. Date: Apr. 2, 2026

(54) SYSTEM AND METHOD FOR ADAPTING VISION-LANGUAGE MODELS WITH HYPERNETWORKS

(71) Applicant: Robert Bosch GmbH, Stuttgart (DE)

(72) Inventors: Victor Akinwande, Pittsburgh, PA (US); Annamarie Bair, Pittsburgh, PA (US); Jeremy Kolter, Pittsburgh, PA (US); Arash Norouzzadeh, PIttsburgh, PA (US); Devin Willmott, Pittsburgh, PA (US)

(21) Appl. No.: 18/901,603

(22) Filed: Sep. 30, 2024

(51) Int. Cl. G06V 10/80; G06F 40/40; G06V 10/764; G06V 10/82

(52) U.S. Cl. CPC G06V 10/803; G06F 40/40; G06V 10/764; G06V 10/82

(57) ABSTRACT

A computer-implemented method and system relate to training a vision language model (VLM), which includes at least an image encoder and a text encoder. The VLM is trained with data pairs, where a data pair includes (i) image data of a digital image and (ii) text data describing that corresponding image data. The text encoder generates text embeddings using the text data. A hypernetwork generates at least a subset of parameters for the image encoder using the text embeddings. The image encoder generates image embeddings using the image data while at least the subset of parameters is applied. A loss is minimized between the image embeddings and the text embeddings. The VLM and the hypernetwork are updated using the loss. The image encoder is relatively small-scale and employable on a resource-constrained device, such as an edge device.

### TECHNICAL FIELD

This disclosure relates generally to computer vision, and more particularly to training and adapting vision-language models via hypernetworks.

### BACKGROUND

Self-supervised vision-language models (VLMs), trained with contrastive objectives, perform better as one increases their scale. Typically, the image encoders in such models are larger than the text encoders. The inference cost of the text encoder is often amortized by using a predefined set of text-embedding, but not with the image encoder. This poses a challenge for deploying large VLMs especially in resource-constrained environments.

Also, it is commonplace today in deep learning to first pre-train a model on web-scale data and then adapt this model for a specific task using little or no additional data. Despite the widespread success of these models and their lack of a reliance on large-scale labeled datasets, a significant downside is that these models are often on the order of billions of parameters-much larger than their supervised counterparts for a given task at the same accuracy level.

The enormous sizes of image encoders in VLMs are a direct consequence of the scale of their pretraining datasets. These VLMs have image encoders, which are tasked with learning representations across an extraordinarily large data domain. However, small-scale vision encoders struggle to learn such a breadth of representations.

Although there exist a variety of strategies to reduce the memory footprint or inference latency of these massive models, there are some additional burdens to employing these strategies. For example, these strategies are broadly categorized into pruning, quantization, and distillation methods. These methods often include first training a large model, and then applying the chosen technique in a post-hoc fashion. However, many of these methods can require specialized hardware support for actual memory and latency reduction.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method relates to training a machine learning model, which includes an image encoder and a text encoder. The method includes receiving data pairs, where each data pair includes (i) image data of a digital image and (ii) text data that describes that image data. The method includes generating, via the text encoder, text embeddings based on the text data. The method includes generating, via a neural network, at least a subset of parameters for the image encoder using the text embeddings. The method includes generating, via the image encoder, image embeddings based on pixels of the image data while the subset of parameters are applied. The method includes minimizing a loss between the image embeddings and the text embeddings. The method includes updating the machine learning model and the neural network using the loss.

According to at least one aspect, a system includes at least one or more processors and one or more computer memory. The one or more computer memory is in data communication with the one or more processors. The one or more computer memory has computer readable data stored thereon. The computer readable data include instructions that, when executed by one or more processors, causes the one or more processors to perform a method for training a machine learning model that includes an image encoder and a text encoder. The method includes receiving data pairs, where each data pair includes (i) image data of a digital image and (ii) text data that describes that image data. The method includes generating, via the text encoder, text embeddings based on the text data. The method includes generating, via a neural network, at least a subset of parameters for the image encoder using the text embeddings. The method includes generating, via the image encoder, image embeddings based on pixels of the image data while the subset of parameters are applied. The method includes minimizing a loss between the image embeddings and the text embeddings. The method includes updating the machine learning model and the neural network using the loss.

A computer-implemented method of training an image classifier comprising an image encoder. The image encoder is a part of a machine learning model. The machine learning model includes the image encoder and a text encoder. The method includes receiving data pairs, where each data pair includes (i) image data comprising pixels of a respective digital image, and (ii) text data describing that image data. The method includes generating, via the text encoder, text embeddings based on the text data. The method includes generating, via a neural network, at least a subset of parameters for the image encoder using the text embeddings. The method includes generating, via the image encoder, image embeddings based on the pixels of the image data while the subset of parameters are applied. The method includes minimizing a loss between the image embeddings and the text embeddings. The method includes updating the machine learning model and the neural network using the loss. The method includes receiving a set of class data for an image classification task. The method includes generating, via the text encoder, class embeddings using the set of class data. The method includes generating, via the neural network, an updated set of parameters for the image encoder. The image classifier includes the image encoder with the updated set of parameters. The image classifier uses the class embeddings to perform the image classification task.

These and other features, aspects, and advantages of the present invention are discussed in the following detailed description in accordance with the accompanying drawings throughout which like characters represent similar or like parts. Furthermore, the drawings are not necessarily to scale, as some features could be exaggerated or minimized to show details of particular components.

### BRIEF DESCRIPTION OF THE FIGURES

FIG. 1 is a diagram that shows aspects of HyperCLIP according to an example embodiment of this disclosure.

FIG. 2 is a diagram that shows an example of an architecture of the hypernetwork of FIG. 1 according to an example embodiment of this disclosure.

FIG. 3 is a diagram of an example of a system with HyperCLIP the according to an example embodiment of this disclosure.

FIG. 4 is a diagram of an example of a process of generating a task-specific network via HyperCLIP according to an example embodiment of this disclosure.

FIG. 5 illustrates an example of a smartphone with a task-specific network according to an example embodiment of this disclosure.

FIG. 6 illustrates an example of an electric appliance with a task-specific network according to an example embodiment of this disclosure.

FIG. 7 illustrates an example of a control system with a task-specific network according to an example embodiment of this disclosure.

FIG. 8 illustrates an example of mobile machine technology that includes a control system with a task-specific network according to an example embodiment of this disclosure.

FIG. 9 illustrates an example of manufacturing technology that includes a control system with a task-specific network according to an example embodiment of this disclosure.

FIG. 10 illustrates an example of security technology that includes a control system with a task-specific network according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

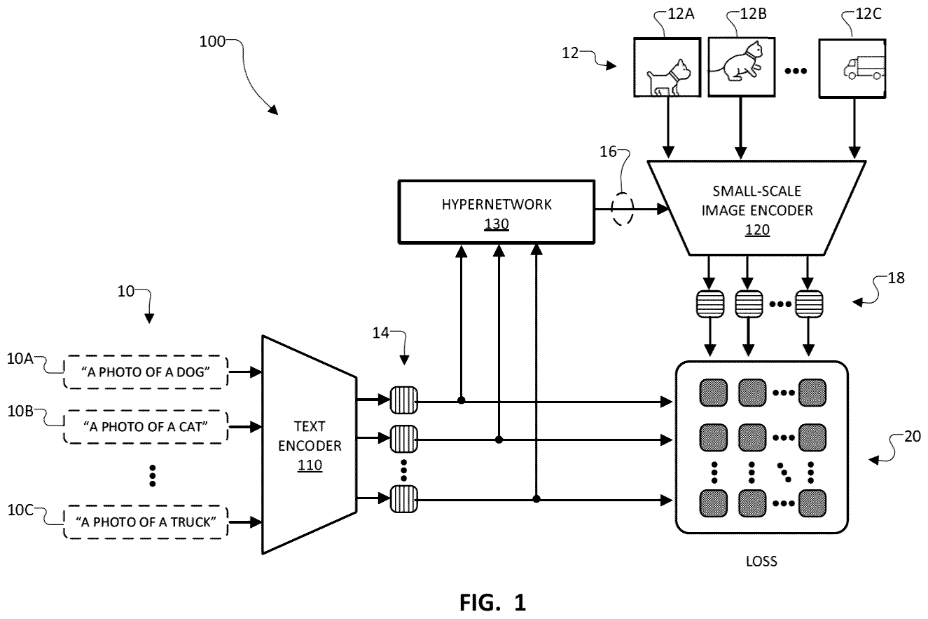

FIG. 1 is a diagram of an example of a system for training and adapting a vision-language model (VLM) via a hypernetwork 130. This system may be referred to as “HyperCLIP” 100 in which “Hyper” refers to the hypernetwork and “CLIP” refers to contrastive language image pretraining (CLIP). HyperCLIP 100 is a system, which includes a process of pre-training or training a VLM to derive a small vision model (e.g., a small-scale image encoder 120), which is appropriate for deployment on resource-constrained systems (e.g., edge devices, etc.) without requiring multi-step training procedures or any specialized hardware. HyperCLIP 100 comprises a novel architecture that improves performance over current state-of-the-art baselines and may additionally be used in conjunction with a variety of model compression methods for further memory or latency improvements.

At a high level, the HyperCLIP 100 involves a machine learning system, which includes at least a VLM and a neural network. This machine learning system may be referred to as “the HyperCLIP model.” The VLM includes at least the text encoder 110 and the image encoder 120. Meanwhile, the neural network includes at least the hypernetwork 130. That is, as shown in FIG. 1, the machine learning system (i.e., the HyperCLIP model) includes at least three main components: (i) a text encoder 110, (ii) an image encoder 120, and (iii) a hypernetwork 130.

The HyperCLIP model is pretrained or trained with training data, which includes data pairs. As an example, a data pair includes (i) image data and (ii) text data associated with that image data. The image data 12 comprises pixels of a digital image. In digital imaging, a pixel is the smallest addressable element in a raster image or a dot matrix display device. In most digital display devices, pixels are the smallest element that can be manipulated through software. Each pixel is a sample or a part of a digital image. The intensity of each pixel is variable. Meanwhile, the text data includes a caption that is associated with the corresponding image data. The text data may describe the image data. The caption may include a prompt.

Referring to FIG. 1, as a non-limiting example, the training data includes a batch of data pairs. The data pairs include text data 10 and image data 12. More specifically, FIG. 1 illustrates three data pairs of at least a part of a batch as non-limiting examples of training data. For instance, the first data pair includes (i) text data 10A of “a photo of a dog” and (ii) corresponding image data 12A that displays a dog. The second data pair includes (i) text data 10B of “a photo of a cat” and (ii) corresponding image data 12B that displays a cat. The third data pair includes (i) text data 10C of “a photo of a truck” and (ii) corresponding image data 12C that displays a truck. In these examples, for convenience of illustration, a prompt of “a photo of {object}” was used in generating each caption, but the text data 10 does not require prompts and may include any applicable image description associated with the image data 12.

Referring to FIG. 1, the VLM includes the text encoder 110, which is configured to receive text data 10 and generate text embeddings 14 using the text data 10. In other words, the text encoder 110 is configured to receive text data 10 as input and produce one or more latent vectors (e.g., text embeddings 14) in an embedding space (e.g., the CLIP embedding space) as output. As an example, the text encoder 110 is based upon a causal transformer architecture. In FIG. 1, the text encoder 110 is trained from scratch so as to allow for additional freedom in determining the resulting contrastive embedding space. Alternatively, the text encoder 110 may include a pre-trained text encoder (e.g., CLIP text encoder), if desired.

In addition, the VLM includes the image encoder 120, which is configured to receive image data 12 and generate image embeddings 18 using at least (i) pixels of the image data 12 and (ii) output (e.g., subset of parameters 16) of the hypernetwork 130. In other words, the image encoder 120 is configured to receive image data 12 of at least one digital image as input and produce one or more latent vectors (e.g., image embeddings 18) in the same embedding space (e.g., the CLIP embedding space) as the text encoder 110. The image encoder 120 may have a similar functional form as the CLIP image encoder. However, the image encoder 120 is different than the CLIP image encoder. In this regard, the image encoder 120 is substantially smaller than the CLIP image encoder. For example, a total number of all parameters of the image encoder 120 is significantly less than a total number of all parameters of the CLIP image encoder. The image encoder 120 consumes less resources (e.g., memory, processing, etc.) than the CLIP image encoder. The image encoder 120 is also more efficient and faster than the CLIP image encoder. The image encoder 120 has greater computational efficiency than the CLIP image encoder. In addition, the image encoder 120 is smaller than the text encoder 110. In this regard, for example, a total number of all parameters of the image encoder 120 is less than a total number of all parameters of the text encoder 110. In contrast, the CLIP image encoder is larger than the CLIP text encoder. Given its significantly smaller size and efficiencies, the image encoder 120 is configured to run on resource-constrained devices, whereas the CLIP image encoder may not run on these same resource-constrained devices because the CLIP image encoder requires greater resources than that which may be available on these same resource-constrained devices. In this regard, the resource-constrained device may be limited with respect to memory, processing, latency, bandwidth, etc.

As discussed above, the image encoder 120 comprises a small vision architecture. As a non-limiting example, the small vision architecture may include EfficientNet (B0, B1, or B2), MobileNetV3 (M0 or M1), TinyNet (T0), EdgeNext (E0), or MobileViT (V0). TABLE 1 provides some details relating to these small vision architectures to highlight their small scale. In particular, TABLE 1 provides information pertaining to (i) “#PARAM (M)” that indicates a total number of all parameters (represented on a scale of millions via “M” for mega) of the small vision architecture, (ii) “#ADAPT (K)” that indicates a total number of parameters (represented on a scale of thousands by “K” for kilo) that are adapted by the hypernetwork 130, and (iii) “TYPE ADAPT” that indicates the type of the parameters that are adapted. In TABLE 1, BN represents BatchNorm parameters, LN represents LayerNorm parameters, and GN represents GroupNorm parameters. As an illustrative example, when using the B0 model of EfficentNet as the small vision architecture for the image encoder 120, then the total number of all parameters of the image encoder 120 is 4.6 million parameters while the total number of adapted parameters (i.e., BN parameters) of the image encoder 120 is 42.1 thousand parameters. The choice of small vision architecture for the image encoder 120 is largely dependent upon the target architecture of a technical system at deployment time.

TABLE 1

| MODEL | B0 | B1 | B2 | M0 | M1 | T0 | E0 | V0 |
|---|---|---|---|---|---|---|---|---|
| # | 4.6 | 7.2 | 8.4 | 4.9 | 2.0 | 1.7 | 7.6 | 4.7 |
| PARAM | | | | | | | | |
| (M) | | | | | | | | |
| # | 42.1 | 62.1 | 67.6 | 24.4 | 12.1 | 17.1 | 8.8 | 15.5 |
| ADAPT | | | | | | | | |
| (K) | | | | | | | | |
| TYPE | BN | BN | BN | BN | BN | BN | LN | BN & GN |
| ADAPT | | | | | | | | |

Referring back to FIG. 1, HyperCLIP 100 includes a new component during a process of developing the small-scale image encoder 120. This new component is the hypernetwork 130. The hypernetwork 130 is configured to map the text embeddings 14 to certain parameters of the image encoder 120 itself. In this regard, the hypernetwork 130 automatically generates at least a subset of parameters 16 (e.g., relevant parameters) of the image encoder 120 based upon the particular task at hand. Specifically, the hypernetwork 130 takes as input the set of text embeddings 14 created by the text encoder 110 and produces as output a subset of parameters 16 of the image encoder 120. The image encoder 120 is configured to apply at least this subset of parameters 16 when generating the image embeddings 18 using the pixels of the image data 12 of the digital images. In this regard, the insight here is that a suitably large hypernetwork 130 may contain the logic of how to “specialize” the image encoder 120 for a given task, precisely the task specified at embedding images which are assumed to be linked to one of the provided text embeddings.

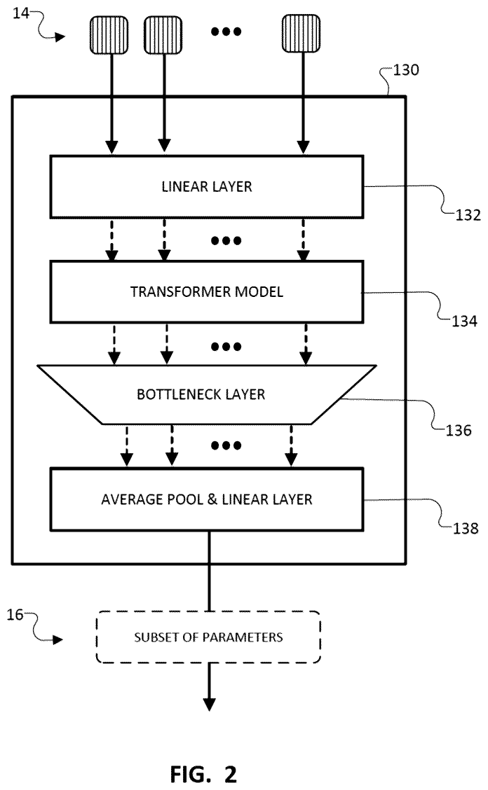

FIG. 2 shows aspects of an example of the hypernetwork 130 of HyperCLIP 100 according to an example embodiment. As an overview, the hypernetwork 130 takes as input a set of text embeddings 14 and outputs at least a subset of parameters 16 for the target image encoder 120. To do so, in the example shown in FIG. 2, the hypernetwork 130 includes at least a linear layer 132, a transformer model 134, a bottleneck layer 136, and an average pool and linear layer 138. More specifically, the linear layer 132 is configured to (i) receive a batch of text embeddings 14 as input vectors of input dimensions and (ii) generate the text embeddings 14 into intermediary vectors of predetermined dimensions, which may be referred to as projected text embeddings and which are compatible with the requirements of the transformer model 134. As a non-limiting example, the linear layer 132 comprises an input projection layer with learnable weights FFᵢₙₚᵤₜ. The transformer model 134 comprises a deep learning architecture of a plurality of transformer layers (i.e., self-attention layers), which are configured to (i) receive the projected text embeddings as input, (ii) “mix” information of the input and learn to differentiate classes and concepts represented by the projected text embeddings, and (iii) generate first intermediate vectors of parameters as output. As a non-limiting example, the transformer model 134 is a transformer encoder that comprises a twelve-layer transformer model 134 having a width of 768, 8 heads, T feed forward dimension of 2560 with GELU activation, no masking, and dropout of 0.1. The bottleneck layer 136 is configured to convert the first intermediate vectors of parameters into second intermediate vectors of parameters, whereby a dimension of the second intermediate vector of parameters is less than a dimension of the first intermediate vector of parameters. In other words, the bottleneck layer 136 generates an output, which is a compressed representation of its input. The average pool and linear layer 138 is configured to (i) receive the second intermediate vectors of parameters, (ii) generate third intermediate vectors of average values of parameters associated with an entire batch of text embeddings, (iii) transform third intermediate vectors of average values of particular dimensions to output vectors of predetermined output dimensions, and (iv) output at least the output vectors, which include at least a subset of parameters 16 (e.g., normalization parameters) for the image encoder 120. In this case, the subset of parameters 16 include normalization parameters. The normalization parameters include scale and bias parameters. The subset of parameters forms a single set of normalization parameters for the batch of text embeddings. As a non-limiting example, the average pool and linear layer 138 comprises a layer normalization LN and an output feed-forward layer FFₒᵤₜₚᵤₜ. The output dimension of the output feed-forward layer FFₒᵤₜₚᵤₜ is the number of parameters 16 being adapted for the image encoder 120.

As discussed above, with this configuration, the hypernetwork 130 is configured to process text embeddings 14 via the transformer model 134 and directly output at least a subset of parameters 16 (e.g., normalization parameters). This setting leads to some natural constraints and invariances that are desirable in the hypernetwork 130 itself, as well as important considerations about what parameters are being produced. For example, with respect to the hypernetwork setting, the hypernetwork 130 should take, as input, any number of text embeddings 14 as input. The hypernetwork 130 should produce a reasonable image encoder 120 not just for a fixed batch size of potential prompts, but indeed for any number of prompts (up to some reasonable limit on size constraints). Additionally, with respect to the hypernetwork setting, the hypernetwork 130 should be invariant to the ordering of these text embeddings: the “order” of the prompts provided to the hypernetwork 130 is entirely incidental and should have no bearing on the target image encoder 120. Fortunately, the transformer model 134 (with variably-sized collections of inputs, and with no causal masking or position encoding) satisfies these two desiderata. Thus, the hypernetwork 130 comprises a noncausal transformer model 134, with each individual prompt embedding serving as a single “token” input to the transformer model used to produce the final parameters of the image encoder 120. Alternatively, the hypernetwork 130 may also use global average pooling over the last layer of embeddings in the hypernetwork 130, though in practice this causes little difference in performance. The resulting hypernetwork 130 is configured to take all the inputted prompts and output a single set of image encoder parameters that produces an image encoder 120 capable of maximally distinguishing between images corresponding to all such prompts.

In FIG. 2, the hypernetwork 130 adopts the approach of only modifying the normalization (e.g., BN, LN, GN) bias and scale parameters of the target image encoder 120. In alternative embodiments, the hypernetwork 130 is configured to output all parameters of the image encoder 120. More specifically, small-scale image encoders 120 typically have on the order of tens of thousands of such parameters, making them a valuable target for the hypernetwork 130, in that they still are known to provide a very powerful control surface of the target model (i.e., the image encoder 120), while being relatively small in number. HyperCLIP 100 also trains the remaining parameters (i.e., convolutional filters and multilayer perceptron (MLP) weights) of the image encoder 120, but HyperCLIP 100 does so in manner that is shared across all the different prompts within training: that is, these non-BN/LN parameters are shared over all different batches of training, while only the BN/LN parameters are the subset of parameters 16, which are adapted according to the output of the hypernetwork 130.

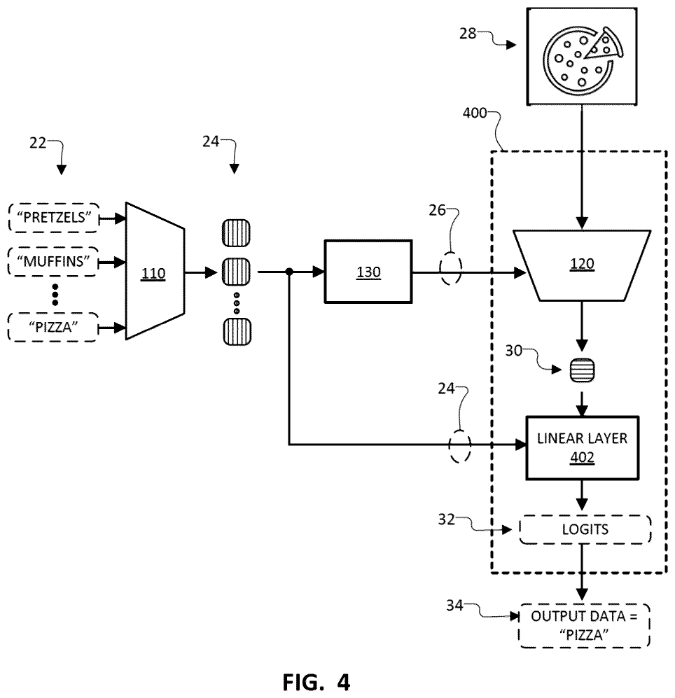

Referring back to FIG. 1, as an overview, HyperCLIP 100 trains the text encoder 110, the image encoder 120, and the hypernetwork 130 simultaneously using a contrastive loss, SigLIP-based loss, or an applicable loss function. The loss function includes computing a dot product 20 between the text embeddings 14 and the image embeddings 18 to calculate the similarity thereof. Notably, at test time, only the small-scale image encoder 120 actually produced by the hypernetwork 130 based upon the desired set of class data 22 (e.g., class prompts) is used, as shown and discussed in FIG. 4. In other words, the image encoder 120, which is produced via HyperCLIP 100, may be directly applied to efficient test-time classification without the need for a separate distillation phase to “shrink” the network to some smaller target architecture.

More formally, as a preliminary, HyperCLIP 100 may be expressed with the following notations. For a given image encoder (e.g., image encoder 120), [symbol] : [symbol] ^{batch×img}→ [symbol] ^{batch×emb}; text encoder (e.g., text encoder 110), [symbol] : [symbol] ^{batch×ctx}→ [symbol] ^{batch×emb}; and hypernetwork, [symbol] : [symbol] ^{batch×emb}→ [symbol] ^{mdim}, the training objective is siglip: [symbol] ^{batch×emb}→ [symbol] ^{batch×emb}× [symbol] ^{batch×emb}= [symbol] ^{batch} and the zero-shot inference metric is sim: [symbol] ^{batch×emb}× [symbol] ^{classes×emb}→ [symbol] ^{batch×classes}. Furthermore, the image encoder 120 has parameters, Θ={Θ₁ . . . θ_{L}}, where θₗ are parameters of each layer. Also, L, batch, classes, ctx, emb, img, mdim∈ [symbol] , where L represents a number of layers of the image encoder 120, batch represents the number of data pairs in a batch, classes represents the number of classes, ctx represents the dimensionality of the text input, emb represents the dimensionality of each embedding, img represents the dimensionality of the image input, and mdim represents the number of parameters that are output by the hypernetwork 130 (i.e., the number of parameters of the image encoder 120 that are being modified by the hypernetwork 130).

With respect to the formal notations described above, HyperCLIP 100 includes training and inference steps, as described below. Given the image embedding X= [symbol] (images;Θ) and text embedding Y= [symbol] (captions), the hypernetwork 130, [symbol] (Y;Φ), takes the text embeddings Y as input and dynamically generates at least a subset of parameters 16 for the image encoder 120. Here, Φ represents the weights of the hypernetwork 130. HyperCLIP 100 defines Θ′={γ,β}, which specifically refers to the normalization parameters generated from the hypernetwork 130. The loss function is defined similarly to SigLIP loss, but with dynamically generated normalization parameters.

$${X}^{′} = ℱ ( images ; {Θ}_{fixed} , {Θ}^{′} ) \qquad [ 1 ]$$

$$\vert b \vert = ( 2 * ) - 1 \qquad [ 2 ]$$

$$hyperclip ( {X}^{′} , Y ; η , ς ) = {- log sigmoid}_{batch} ( \vert b \vert * ( η * ( {X}^{′} ⊙ Y ) + ζ ) ) \qquad [ 3 ]$$

In equation 1, Θ_{fixed} represents the fixed parameters of the image encoder 120, while O′ represents the normalization parameters (i.e., the subset of parameters 16) generated by the hypernetwork 130. The image embedding X′ is obtained by using both fixed and dynamic parameters in the image encoder 120. The “fixed” parameters are still being updated during training. In equation 2, |b|=(2* [symbol] )−1 may be defined a matrix of 1's on the diagonals and 1's otherwise. In equation 3, HyperCLIP defines a measure sim (X′, Y)=X′⊙Y of similarity between a given image and text embedding where ⊙ is the matrix product. This measure allows an inference rule such as

$$pred = {arg max sim}_{classes} ( {X}^{′} , Y )$$

is used to predict a text caption for each class. Furthermore, during training, the process includes optimizing the loss over a batch as expressed in equation 4. Also, n, ζ∈ [symbol] are parameters in equations 3 and 4.

$$loss = min {\sum }_{batch} hyperclip ( {X}^{′} , Y ; η , ζ ) \qquad [ 4 ]$$

Finally, the process may include finetuning a linear layer 402 (i.e., linear probe) of the image encoder 120 with its weights initialized with Y via equation 5, where Y*∈R^{batch} are evaluation labels for each digital image.

$$probe = minimize {\sum }_{batch} {- log softmax}_{batch} ( {X}^{′} ) ⊙ {Y}^{*} \qquad [ 5 ]$$

For zero-shot classification, X′ is explicitly conditioned on Y using the hypernetwork 130 before the argmax, as expressed in equation 6.

$$sim ( {X}^{′} , Y ) = {X}^{′} ⊙ Y \qquad [ 6 ]$$

$$pred = {arg max sim}_{classes} ( {X}^{′} , Y )$$

During training, HyperCLIP 100 freezes the normalization parameters (i.e., the subset of parameters 16), keeps the scale parameters γ positive by applying the exponential function, and uses the running average estimate of the population statistics. The image embeddings 18 are obtained only after the normalization parameters (or the subset of parameters 16) of the image encoder 120 have been modified by the hypernetwork 130 during the forward pass. During the backward pass, the text encoder 110, the remaining parameters of the image encoder 120, and the hypernetwork 130 are updated using the gradient of SigLIP loss computed using Y and X. Also, HyperCLIP 100 is configured obtain the desired prompts and use them to fix the parameters of the associated image encoder 120 before starting inference. Since HyperCLIP 100 does not modify or add any parameters to the image encoder 120 at inference time, the cost remains unchanged relative to a baseline model.

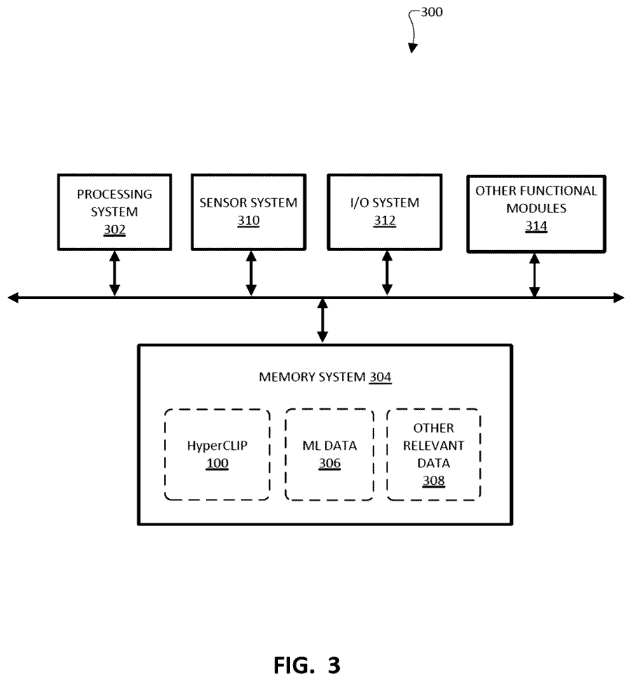

FIG. 3 is a diagram of an example of a system 300 with HyperCLIP 100 according to an example embodiment of this disclosure. The system 300 includes at least a processing system 302. The processing system 302 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 302 is operable to provide the functionality as described herein.

The system 300 includes at least a memory system 304, which is operatively connected to the processing system 302. The memory system 304 is in data communication with the processing system 302. In an example embodiment, the memory system 304 includes at least one non-transitory computer readable medium, which is configured to store and provide access to various data to enable at least the processing system 302 to perform the operations and functionality, as disclosed herein. In an example embodiment, the memory system 304 comprises a single device or a plurality of devices. The memory system 304 can include electrical, electronic, magnetic, optical, semiconductor, electromagnetic, or any suitable storage technology that is operable with the system 300. For instance, in an example embodiment, the memory system 304 can include random access memory (RAM), read only memory (ROM), flash memory, a disk drive, a memory card, an optical storage device, a magnetic storage device, a memory module, any suitable type of memory device, or any combination thereof.

The memory system 304 includes at least HyperCLIP 100, machine learning (ML) data 306, and other relevant data 308, which are stored thereon. The memory system 304 includes computer readable data that, when executed by the processing system 302, is configured to implement pretraining or training process of HyperCLIP 100 to provide the functions as described in at least FIG. 1, FIG. 2, and FIG. 4. The computer readable data can include instructions, code, routines, various related data, any software technology, or any number and combination thereof. Specifically, HyperCLIP 100 comprises a machine learning system that includes (i) a machine learning model (e.g., a VLM) comprising at least text encoder 110 and image encoder 120 and (ii) a neural network comprising at least hypernetwork 130. Also, the ML data 306 includes various training data, various loss data, various weight data and/or parameter data, as well as any related machine learning data that enables the system 300 to perform the functions as disclosed in this disclosure. The training data includes various data pairs of text data and image data, where each text data of a data pair describes corresponding image data of that data pair. Meanwhile, the other relevant data 308 provides various data (e.g. operating system, etc.), which enables the system 300 to perform the functions as discussed herein.

In an example embodiment, as shown in FIG. 3, the system 300 is configured to include at least one sensor system 310. The sensor system 310 includes one or more sensors. For example, the sensor system 310 includes an image sensor or a camera. The sensor system may also include a radar sensor, a light detection and ranging (LIDAR) sensor, a thermal sensor, an ultrasonic sensor, an infrared sensor, a motion sensor, an audio sensor, an inertial measurement unit (IMU), any suitable sensor, or any combination thereof. The sensor system 310 is operable to communicate with one or more other components (e.g., processing system 302 and memory system 304) of the system 300. More specifically, for example, the processing system 302 is configured to obtain the sensor data directly or indirectly from at least the image sensor. The sensor data may also be taken from one or more sensors of the sensor system 310. Upon receiving the sensor data, the processing system 302 is configured to process this sensor data (e.g., digital image) in connection with HyperCLIP 100 and the ML data 306.

In addition, the system 300 includes other components that contribute to HyperCLIP 100. For example, as shown in FIG. 3, the memory system 304 is also configured to store other relevant data 308, which relates to operation of the system 300 in relation to one or more components (e.g., sensor system 310, an input/output (I/O) system 312, and other functional modules 314). In addition, the I/O system 312 includes an I/O interface and may include one or more devices (e.g., display device, keyboard device, speaker device, etc.). Also, the system 300 includes other functional modules 314, such as any appropriate hardware technology, software technology, or combination thereof that assist with or contribute to the functioning of the system 300. For example, the other functional modules 314 include communication technology that enables components of the system 300 to communicate at least with each other, as described herein. The communication technology may allow for the system 300 to communicate with other network devices (not shown) over a communication network. With at least the configuration discussed in the example of FIG. 3, the system 300 is operable for HyperCLIP 100 to perform the process and functions as discussed in this disclosure.

FIG. 4 is a diagram that illustrates aspects of an example of a process of generating a task-specific network 400 according to an example embodiment. This process may be performed by one or more processors of the processing system 302 (FIG. 3). Also, this process uses the trained HyperCLIP model (e.g., trained text encoder 110, trained image encoder 120, and trained hypernetwork 130) to generate the task-specific network 400. That is, this process occurs after the pretraining or training process of FIG. 1. Furthermore, in this particular example, the process relates to generating a task-specific network 400 for image classification based on the set of class data 22. Specifically, in FIG. 4, the task-specific network 400 is an image classifier, which includes at least the trained image encoder 120, the linear layer 402, and logits computations. Alternatively, the trained image encoder 120 may be a part of a task-specific network 400, which is further trained to perform another specific task, such as dataset shift, linear probing tasks, image retrieval recall, or any applicable computer vision task.

Referring to FIG. 4, as a non-limiting example, for a specific image classification task, the process includes receiving or obtaining a set of class data 22. The class data 22 may comprise a class name, a class description, or any similar descriptive text data. Referring to FIG. 4, as a non-limiting example, the set of class data 22 includes at least “pretzels,” “muffins,” “pizza,” and other food captions/descriptions/names. The set of class data 22 are passed to the trained text encoder 110.

The trained text encoder 110 is configured to receive the set of class data 22. The trained text encoder 110 is configured to generate a set of class embeddings 24 using the set of class data 22. The set of class embeddings 24 are transmitted to (i) the trained hypernetwork 130 and (ii) the linear layer 402. In the first transmission example, the trained hypernetwork 130 is configured to receive the set of class embeddings 24 and generate at least an updated subset of parameters (e.g., normalization parameters 26) for the trained image encoder 120. The image encoder 120 is updated using at least this updated subset of parameters. Also, in the second transmission example, the linear layer 402 is configured to receive the class embeddings 24 from the trained text encoder 110. The class embeddings 24 serve as weights of the linear layer 402. Upon performing these updates, the task specific network 400 is deployable and/or employable as an image classifier.

For an image classification task, the trained image encoder 120 is configured to receive at least one digital image 28. The trained image encoder 120 is configured to generate image embeddings 30 using pixels of image data of at least one digital image 28 while at least the updated subset of parameters (e.g., normalization parameters 26) are applied and/or used by the trained image encoder 120. The linear layer 402 receives the image embeddings 30. The linear layer 402 generates a result by transforming the image embeddings 30 while using the class embeddings 24 as weights. Next, the logits 32 are computed based on the result. The logits 32 form the likelihoods over the set of class data 22. For class prediction, the process includes taking the class data 22 associated with the highest probability or greatest likelihood taken from the logits 32. In this case, the task-specific network 400 is configured to (i) determine that “pizza” is the class data with the highest probability or greatest likelihood using the logits 32 and (ii) generate output data 34 of “pizza” as the class data 22 that classifies the digital image 28.

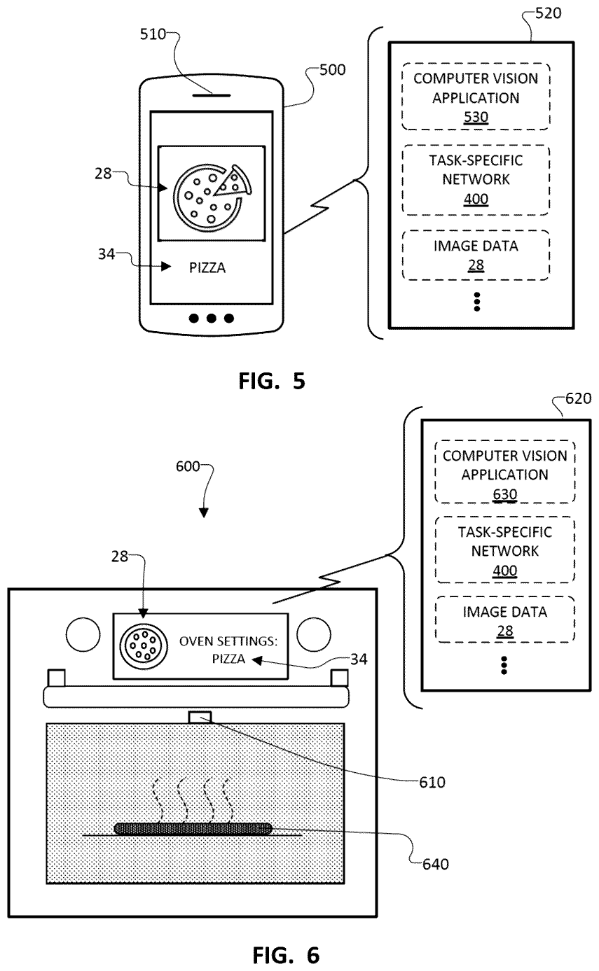

FIG. 5 illustrates an example of the deployment and employment of the task-specific network 400 on a resource-constrained computing device according to an example embodiment. As aforementioned, the task specific network 400 is relatively small-scale and is therefore deployable and employable on resource-constrained devices. For example, the resource-constrained device may be a kiosk machine. The resource-constrained device may be edge device. The resource-constrained device may be an internet of things (IOT) device.

In FIG. 5, as a non-limiting example, the task-specific network 400 is deployed and employed on a mobile device, such as a smartphone 500. The smartphone 500 includes at least one camera 510, which is configured to capture and generate digital images (e.g., digital image 28) and/or digital video. The smartphone 500 also includes at least one processing device (not shown) and at least one memory 520. The memory 520 includes computer readable data with instructions stored thereon. The computer readable data, which is executable by at least one processor or processing device, includes at least a computer vision application 530 and the task-specific model 400. The smartphone 500 is configured to use the task-specific network 400 to generate output data 34 (“pizza”), which classifies the digital image 28. In this example, the computer vision application 530 along with the task-specific network 400 may be used to help a user classify, identify, describe, and/or tag digital images, which have been captured, received, or obtained via the smartphone 500. The smartphone 500, via the computer vision application 530, may be configured to display the output data 34 (e.g., pizza) of the task-specific network 400 along with other information (e.g. digital image 28, etc.) relating to that output data 34.

FIG. 6 illustrates an example of the deployment and employment of the task-specific network 400 in a resource-constrained environment according to an example embodiment. As aforementioned, the task specific network 400 is relatively small-scale and is therefore deployable and employable on resource-constrained devices. For example, the resource-constrained device may be an electric appliance.

In FIG. 6, as a non-limiting example, the task-specific network 400 is deployed and employed on a home appliance, such as an oven 600. The oven 600 may be a smart oven. The oven 600 includes at least one camera 610, which is configured to capture and generate digital images (e.g., digital image 28) and/or digital video. The oven 600 also includes at least one processing device (not shown) and at least one memory 620. The memory 620 includes computer readable data with instructions stored thereon. The computer readable data, which is executable by at least one processor or processing device, includes at least a computer vision application 630 and the task-specific model 400. The computer vision application 630 is an application program that uses the output data 34 (e.g. pizza) of the task-specific network 400 and presents this information to the user. The oven 600 may include a display device to display the output data 34 (e.g., pizza) along with other information (e.g., recommended oven/cooking settings) relating to that output data 34. The display device may also display the input (e.g., digital image 28) of the task specific network 400. For example, in this non-limiting example, the oven 600 obtains at least one digital image 28 of a pizza and further generates output data 34 (“pizza”), which classifies the digital image 28. In this case, the computer vision application 630 and/or task-specific network 400 may be used to help a user classify one or more items 630 for cooking in the oven 600 via the digital image 28. Upon performing the classification task, the oven 600 and/or computer vision application 630 is configured to automatically recommend and/or set the cooking settings (e.g., bake mode, cooking time, temperature, etc.) for that item 640.

FIG. 7 illustrates another example of a system 700 with a relatively small task-specific network 400 according to an example embodiment. In this example, the system 700 includes at least a sensor system 710, a control system 720, and an actuator system 730. The system 700 is configured such that the control system 720 controls the actuator system 730 based on sensor data from the sensor system 710. More specifically, the sensor system 710 includes one or more sensors and/or corresponding devices to generate sensor data. For example, the sensor system 710 includes at least an image sensor, a radar sensor, a LIDAR sensor, a thermal sensor, an ultrasonic sensor, an infrared sensor, a motion sensor, a satellite-based navigation sensor (e.g., Global Positioning System (GPS) sensor), an optical sensor, an audio sensor, any suitable sensor, or any combination thereof. Upon obtaining detections of its environment, the sensor system 710 is operable to communicate with the control system 720 via an I/O system 760 and/or other functional modules 770, which includes communication technology. The control system 720 is configured to obtain the sensor data directly or indirectly from one or more sensors of the sensor system 710. In this regard, the sensor data may include sensor data from a single sensor or sensor-fusion data from a plurality of sensors. Upon receiving input, which includes at least sensor data, the control system 720 is operable to process the sensor data via a processing system 740 to ensure that the sensor data is of suitable form (e.g., digital images) for the task-specific network 400.

The processing system 740 includes at least one processor. For example, the processing system 740 includes an electronic processor, CPU, a GPU, a microprocessor, an FPGA, ASIC, processing circuits, any suitable processing technology, or any combination thereof. Upon processing at least this sensor data (e.g., digital image), the processing system 740 is operable to generate output data (e.g., classification from the task specific network 400) based on communications with memory system 750. In addition, the processing system 740 is operable to provide actuator control data to the actuator system 730 based on the output data.

The memory system 750 is a computer or electronic storage system, which is configured to store and provide access to various data to enable at least the operations and functionality, as disclosed herein. The memory system 750 comprises a single device or a plurality of devices. The memory system 750 includes electrical, electronic, magnetic, optical, semiconductor, electromagnetic, any suitable memory technology, or any combination thereof. For instance, the memory system 750 may include RAM, ROM, flash memory, a disk drive, a memory card, an optical storage device, a magnetic storage device, a memory module, any suitable type of memory device, or any combination thereof.

The memory system 750 includes at least a computer vision application 780, a task specific network 400, and other relevant data 790, which are each configured to be executed and/or implemented via the processing system 740. The computer vision application 780 is configured to provide an application program for computer vision technology using the output of the task-specific network 400. The memory system 750 includes computer readable data that, when executed by the processing system 740, is configured to run the computer vision application 780 and employ the task-specific network 400 to perform a specific task (e.g., image classification tasks, dataset shift tasks, linear probing tasks, image retrieval recall, etc.). The computer readable data can include instructions, code, routines, various related data, any software technology, or any number and combination thereof.

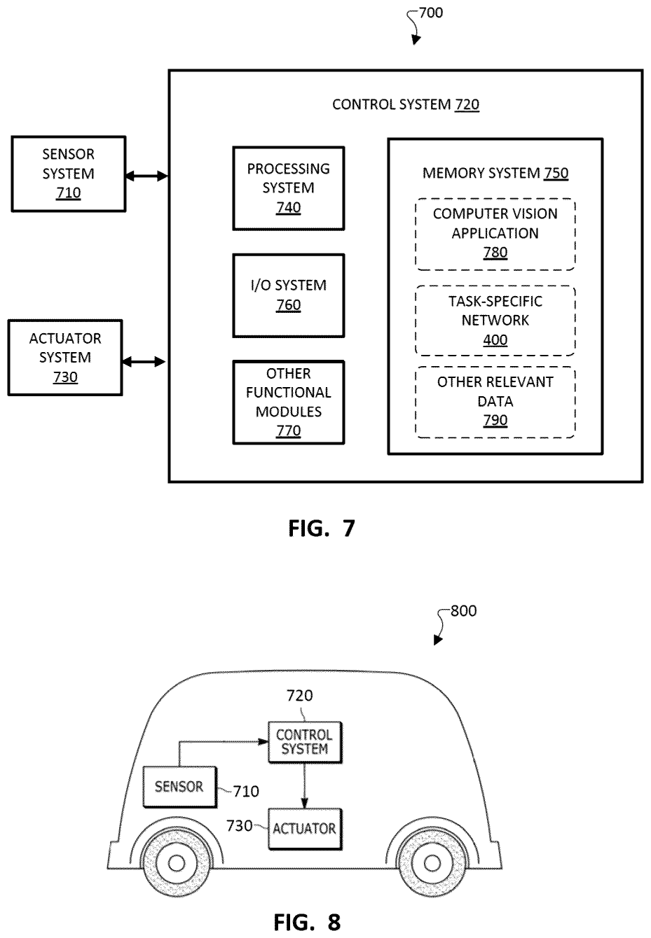

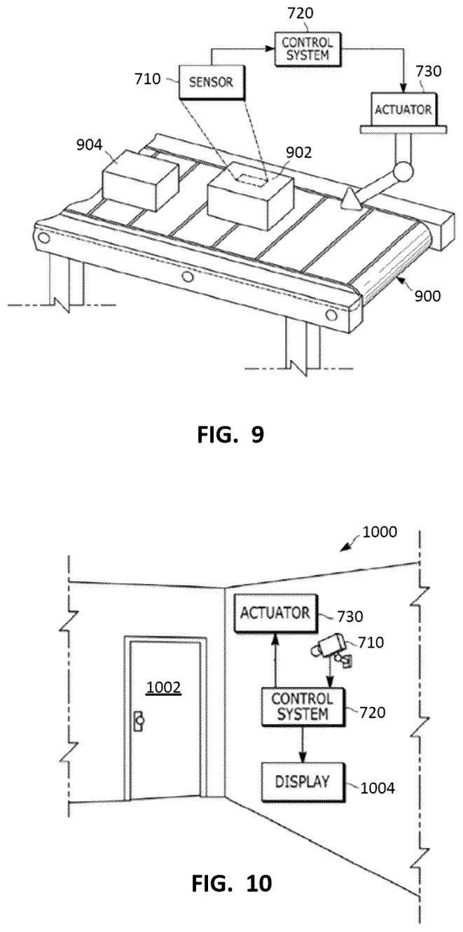

As aforementioned, the task-specific network 400 includes at least the trained image encoder 120 and is further set up to perform a specific task. For example, in FIG. 4, FIG. 5 and FIG. 6, the task-specific network 400 is set up as an image classifier via the set of class data 22 (e.g., food descriptions) to classify digital images according to that set of class data 22. In addition, FIG. 8, FIG. 9, and FIG. 10 include different task-specific networks 400 that are configured as image classifiers. Specifically, each one of FIG. 8, FIG. 9, and FIG. 10 have a control system 720 with a task-specific network 400, which is set up via a similar process as that of FIG. 4 for an image classifier, but with a different set of class data 22 relating to their target application. For instance, FIG. 8 may include a task-specific network 400 that is set up as an image classifier with a set of class data 22 that relates to driving scene objects (e.g., road signs, motorcycles, vehicles, pedestrians, bicycles, etc.) encountered while controlling a vehicle. In contrast, FIG. 9 may include a task-specific network 400 that is set up as an image classifier with a set of class data 22 that relates to states of manufactured product 902. As yet another example, FIG. 10 may include a task-specific network 400 that is set up as an image classifier with a set of class data 22 that relates to security detections (e.g., person 1, person 2, dog, cat, bird, etc.), which may be encountered around a door 1002. In general, in these different examples, the task-specific network 400 refers to a vision model, which includes at least the trained image encoder 120 and which is set up to perform a specific task. In these examples, the task-specific network 400 is configured to perform an image classification task, but the task-specific may be configured and set up to perform another task (e.g., dataset shift tasks, linear probing tasks, image retrieval recall, etc.) for a target computer vision application.

Furthermore, as shown in FIG. 7, the system 700 includes other components that contribute to operation of the control system 720 in relation to the sensor system 710 and the actuator system 730. For example, as shown in FIG. 7, the memory system 750 is also configured to store other relevant data 790, which relates to the operation of the system 700 in relation to one or more components (e.g., sensor system 710, the actuator system 730, etc.). Also, as shown in FIG. 7, the control system 720 includes the I/O system 760, which includes one or more interfaces for one or more I/O devices that relate to the system 700. For example, the I/O system 760 provides at least one interface to the sensor system 710 and at least one interface to the actuator system 730. Also, the control system 720 is configured to provide other functional modules 770, such as any appropriate hardware technology, software technology, or any combination thereof that assist with and/or contribute to the functioning of the system 700. For example, the other functional modules 770 include an operating system and communication technology that enables components of the system 700 to communicate with each other as described herein. With at least the configuration discussed in the example of FIG. 7, the system 700 is applicable in various technologies.

FIG. 8 is a diagram of the system 700 with respect to mobile machine technology 800 according to an example embodiment. The mobile machine technology 800 may be any mobile machine that includes at least a control system 720, a sensor system 710 and an actuator system 730. As a non-limiting example, in FIG. 8, the mobile machine technology 800 includes at least a partially autonomous vehicle. The mobile machine technology 800 is at least a partially autonomous vehicle, which includes the sensor system 710. One or more of the sensors may be integrated with respect to the vehicle.

The control system 720 is configured to obtain image data (e.g., digital images), which is based on sensor data or sensor-fusion data from the sensor system 710. The control system 720 is configured to detect objects in a vicinity of the vehicle based on the sensor data. The control system 720 is configured to provide input images to the computer vision application 780 and the task-specific network 400. The task-specific network 400 is configured to classify the digital images received from the sensor system 710 with respect to autonomous driving. For instance, as a non-limiting example, the task-specific network 400 is configured to classify a digital image as belonging to the “stop sign” class with a greatest likelihood. The control system 720 is configured to generate an actuator control data for a braking operation in response to the classification of the object as “stop sign.” In this case, the actuator system 730 is configured to stop the vehicle upon receiving the actuator control data. In this regard, the actuator system 730 may include a braking system, a propulsion system, an engine, a drivetrain, a steering system, and/or any applicable actuation system of the vehicle. The actuator system 730 is configured to control the vehicle so that the vehicle follows rules of the roads and avoids collisions via the computer vision application 780 based on the classifications provided by the task-specific network 400.

In addition, as another non-limiting example, the mobile machine technology 800 includes at least a partially autonomous robot. The robot may be an edge device. As a non-limiting example, the mobile machine technology may be a vacuum robot, a lawnmower robot, a cleaning robot, etc. As another non-limiting example, the mobile machine technology may be a drone. For example, the robot is configured to carry out one or more functions such as flying, driving, stepping, maneuvering, etc. The robot may be at least a partially autonomous lawn mower or a partially autonomous cleaning robot. In this regard, the actuator system 730 is configured to control, drive, steer, or stop the robot so that the robot avoids collisions based on image classifications provided by the task-specific network 400.

Furthermore, as yet another non-limiting example, the mobile machine technology 800 includes at least a partially autonomous robot in the form of a gardening robot. In this example, the control system 720 is configured to provide the task-specific network 400 with input images based on sensor data. The task-specific network 400 is configured to classify these input images to identify a state of the plants in the environment and/or the species of plants in the environment. The control system 720 is further configured to generate actuator control data based on the classifications (e.g., state of plants or identified species of plants) so that the actuator system 730 is configured to provide a suitable quantity of water, gardening chemicals and/or treatments.

FIG. 9 is a diagram of the system 700 with respect to manufacturing technology 900 according to an example embodiment. As a non-limiting example, the manufacturing technology 900 includes a punch cutter, a cutter, a gun drill, or any suitable type of manufacturing machine. In FIG. 9, the sensor system 710 includes at least one image sensor or optical sensor. The control system 720 is configured to obtain image data from the sensor system 710. The task-specific network 400 is configured to classify each digital image, which shows a state of a manufactured product 902. For example, the control system 720 may classify a current state of the manufactured product 902 from among various states in the manufacturing process. The control system 720 is configured to determine or select an actuator control data in response to the classification of the current state of the manufactured product 902 based on properties captured by the sensor system 710. For instance, as a non-limiting example, the actuator control data may cause the control system 720 to actuate a next manufacturing step 904 of the manufacturing process based on the classified state of the manufactured product 902.

FIG. 10 is a diagram of the system 700 with respect to security technology 1000 according to an example embodiment. As a non-limiting example, the security technology 1000 includes at least a monitoring system, a control access system, a surveillance system, or any suitable type of security apparatus. For instance, as one example, FIG. 10 may relate to security technology 1000, which is configured to physically control a locked state and an unlocked state of the door 1002. The sensor system 710 includes at least an image sensor that is configured to capture digital images and/or digital video. The control system 720 is configured to obtain the digital images and/or the digital video from the sensor system 710. The control system 720 is configured to provide a digital image to the task-specific network 400. For example, the task specific network 400 may classify objects that may typically be around a particular door. For example, the task-specific network 400 may classify image data of a digital image as including a facial image that belongs to person 1, person 2, . . . or, person N, where N represents an integer number. Additionally or alternatively, the task-specific network 400 may classify animals such as dog, cat, fox, deer, etc. The control system 720 is configured to generate actuator control data in response to the classification that is output by the task-specific network 400. For instance, as a non-limiting example, the actuator control data may cause the control system 720 to lock or unlock the door 1002 when the task-specific network 400 identifies the input image as belonging to person 3. Additionally or alternatively, as another non-limiting example, the actuator control data may cause the control system 720 to display the input data (e.g., digital image or digital video) on the display device 1004 and/or the output data (e.g., person 3) and/or other relevant data. The actuator control data may also cause the control system 720 to transmit that particular digital image and/or digital video together with the corresponding output data of the task-specific network 400 to the appropriate authorities.

As described in this disclosure, HyperCLIP 100 includes a number of advantageous features and benefits. For example, HyperCLIP 100 includes a new architecture designed to enhance VLMs by dynamically adapting the image encoder 120 using a hypernetwork 130. More specifically, HyperCLIP 100 includes at least a novel hypernetwork 130, which takes text embeddings 14 from the text encoder 110 of a VLM and outputs at least the subset of parameters 16 (e.g., weights) of the image encoder 120 of the VLM. In this way, the hypernetwork 130 learns the model weights necessary to represent an image as a function of text associated to that image. This hypernetwork 130 is trained jointly with a text encoder 110 of VLM and an image encoder 120 of the VLM and is compatible with any type of contrastive pre-training.

HyperCLIP 100 includes a method and system, which enables the usage of a much smaller image encoder 120, resulting in inherent compression, i.e., fewer model parameters and faster inference. In this regard, HyperCLIP 100 addresses the challenge of deploying large VLMs in resource-constrained environments (e.g., memory-constrained environment, etc.) by producing a significantly smaller, task-specific image encoder (e.g., image encoder 120) that maintains high performance. HyperCLIP 100 is advantageous in providing a smaller-scale or reduced-size image encoder 120. Additionally, the performance of these small vision models can be improved by several percentage points across a range of tasks when their weights are adapted via HyperCLIP 100. In some cases, a small vision model, trained via HyperCLIP 100, is able to outperform a larger non-adapted vision model.

Also, by conditioning the image encoder parameters on the text embeddings, HyperCLIP 100 achieves consistent and significant improvements in zero-shot accuracy, robustness to distribution shifts, and enhances fairness metrics without the need for extensive post-hoc optimization or specialized hardware. Furthermore, HyperCLIP's ability to produce efficient, high-performing VLMs has implications for democratizing computer vision models enabling their deployment on resource-limited devices and in diverse settings. Additionally, its improved fairness metrics and robustness to distribution shifts may help mitigate biases and enhance the inclusivity of computer vision models across various applications.

In addition, HyperCLIP 100 includes an architecture for learning transferable vision models that are resource efficient and perform on par with their larger non-hypernetwork enhanced counterparts. HyperCLIP 100 dynamically adapts the weights of the vision model during training, thus sidestepping the need for post-hoc optimization. Also, the usage of HyperCLIP 100 to adapt only the normalization layers of several widely used small vision models is sufficient to improve their performance on standard zero-shot classification benchmarks. In addition, HyperCLIP 100 has been demonstrated to improve performance on several distribution shift and fairness tasks relative to baselines.

Also, as a new strategy, instead of fixing vision encoders to account for all possible image captions, HyperCLIP 100 provides a method and system, which are configured to adaptively precondition the image encoder 120 based on each particular text input. By cleverly setting the weights of the image encoder 120, then this enables a much smaller image encoder vision network (e.g., task-specific network 400), which is automatically specialized to a given task, to be used.

In addition, HyperCLIP 100 is advantageous in being configured to directly train a VLM that skips an explicit distillation process entirely, and instead produces an image encoder 120 that is already optimized for use on a particular classification problem. In order to achieve this, HyperCLIP 100 leverages a hypernetwork 130 that produces a specialized image encoder 120 directly for some subset of textual prompts. HyperCLIP 100 is configured to deploy a classifier with the specialized image encoder 120 onto a small embedded device, an edge device, or small-scale technology.

Furthermore, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally, or alternatively, components and functionality may be separated or combined differently than in the manner of the various described embodiments and may be described using different terminology. These and other variations, modifications, additions, and improvements may fall within the scope of the disclosure as defined in the claims that follow.

1. A computer-implemented method for training a machine learning model that includes an image encoder and a text encoder, the computer-implemented method comprising:
receiving data pairs that include image data and text data, each text data describing the corresponding image data of a digital image;
generating, via the text encoder, text embeddings based on the text data;
generating, via a neural network, at least a subset of parameters for the image encoder using the text embeddings;
generating, via the image encoder, image embeddings based on pixels of the image data while the subset of parameters are applied;
minimizing a loss between the image embeddings and the text embeddings; and
updating the machine learning model and the neural network using the loss.

2. The computer-implemented method of claim 1, wherein:
the machine learning model is a vision language model;
the neural network includes a hypernetwork; and
the hypernetwork comprises a non-causal transformer model that includes transformer layers that generate at least the subset of parameters.

3. The computer-implemented method of claim 1, wherein the loss includes a contrastive loss or a sigmoid-based loss.

4. The computer-implemented method of claim 1, wherein the subset of parameters include normalization parameters.

5. The computer-implemented method of claim 1, wherein the subset of parameters include a single group of weights for the image encoder that are associated with a batch of text embeddings.

6. The computer-implemented method of claim 1, wherein:
the image encoder includes another subset of parameters,
the another subset of parameters is not updated according to output of the neural network.

7. The computer-implemented method of claim 1, wherein a total number of all parameters of the image encoder is less than 10 million parameters.

8. The computer-implemented method of claim 1, wherein a total number of all parameters of the image encoder is less than a total number of all parameters of the text encoder.

9. The computer-implemented method of claim 1, further comprising:
obtaining a set of class data for an image classification task;
generating, via the text encoder, class embeddings using the set of class data;
generating, via the neural network, at least an updated subset of parameters for the image encoder; and
outputting an image classifier that includes the image encoder with the updated subset of parameters, the image classifier using the class embeddings to perform the image classification task.

10. The computer-implemented method of claim 9, further comprising:
deploying the image classifier to an edge device,
wherein the edge device is controllable via the image classification task performed by the image classifier.

11. A system comprising:
one or more processors;
one or more computer memory in data communication with the one or more processors, the one or more computer memory having computer readable data stored thereon, the computer readable data including instruction that, when executed by one or more processors, causes the one or more processors to perform a method for training a machine learning model that includes an image encoder and a text encoder, the method including
receiving data pairs that include image data and text data, each text data describing the corresponding image data of a respective digital image;
generating, via the text encoder, text embeddings based on the text data;
generating, via a neural network, at least a subset of parameters for the image encoder using the text embeddings;
generating, via the image encoder, image embeddings based on pixels of the image data while the subset of parameters are applied;
minimizing a loss between the image embeddings and the text embeddings; and
updating the machine learning model and the neural network using the loss.

12. The system of claim 11, wherein:
the machine learning model is a vision language model;
the neural network includes a hypernetwork; and
the hypernetwork comprises a non-causal transformer model that includes transformers that generate at least the subset of parameters.

13. The system of claim 11, wherein the loss includes a contrastive loss or a sigmoid-based loss.

14. The system of claim 11, wherein the subset of parameters include normalization parameters.

15. The system of claim 11, wherein the subset of parameters include a single group of weights for the image encoder that are associated with a batch of text embeddings.

16. The system of claim 11, wherein:
the image encoder includes another subset of parameters,
the another subset of parameters is not updated according to output of the neural network.

17. The system of claim 11, wherein a total number of all parameters of the image encoder is less than 10 million parameters.

18. The system of claim 11, wherein a size of the image encoder is less than a size of the text encoder.

19. The system of claim 11, wherein the method further comprises:
obtaining a set of class data for an image classification task;
generating, via the text encoder, class embeddings using the set of class data;
generating, via the neural network, an updated set of parameters for the image encoder; and
outputting an image classifier that includes the image encoder with the updated set of parameters, the image classifier using the class embeddings to perform the image classification task.

20. The system of claim 19, further comprising:
deploying the image classifier to an edge device,
wherein the edge device is controllable via the image classification task performed by the image classifier.
